(19) United States
(12) Patent Application Publication
(10) Pub. No.: US 2013/0189500 A1
(43) Pub. Date: Jul. 25, 2013

(54) MESH-TYPE DRYWALL TAPE HAVING AN INDEXING PATTERN FOR INDICATING A TAPE EDGE

(71) Applicant: David E. Adams, Yorklyn, DE (US)

(72) Inventor: David E. Adams, Yorklyn, DE (US)

(21) Appl. No.: 13/357,268

(22) Filed: Jan. 24, 2012

(51) Int. Cl. B32B 3/00; D04H 3/04

(52) U.S. Cl. 428/195.1; 28/100

(57) ABSTRACT

A mesh-type drywall tape includes a scrim layer of a plurality of lengthwise strands coupled to a plurality of crosswise strands, wherein the scrim layer includes an indexing pattern for indicating a tape edge. To form the indexing pattern, markings are disposed on multiple strands. In one embodiment, the indexing pattern has a v-shaped configuration with diagonal portions that may vary or alternate in shape and color. The indexing pattern repeats itself along the entire length of the tape.

### BACKGROUND

1. Field of the Invention

The field of the present invention relates to mesh-type drywall tapes having indexing patterns for indicating a tape edge.

2. Background

In the construction industry, drywall panels for walls and ceilings are affixed to wall studs or ceiling joists with drywall screws or other fasteners. The drywall panels are installed adjacent to one another. The spaces or seams between adjacent drywall panels and the heads of the drywall screws or fasteners are covered with mesh-type drywall tape, and then in turn with a series of coats of joint compound (sometimes called “mud”). After the joint compound has dried, it may be sanded to a smooth finish, and sometimes is covered again with a skim coating of joint compound or plaster.

Mesh-type drywall tapes are manufactured with a plurality of strands arranged in an open pattern, having crosswise and lengthwise strands. After formation of the mesh or scrim layer, adhesives are applied to couple the strands and provide an adhesive backing on the underside of the tape. Afterwards, the adhesive backed mesh is wound onto a roller element, typically made of cardboard.

Unfortunately, because of the method of manufacture and materials used for mesh-type drywall tapes, it is difficult to determine starting, torn, or cut edges of tape visually. Visual determination is particularly difficult because most mesh-type drywall tapes are manufactured such that all of the strands are uniform in color. How the strands are positioned when rolled onto a roller also makes visual determination of a tape edge difficult.

In addition, the texture and arrangement of strands can increase difficulty in detecting a tape edge by feel. Many types of mesh-type drywall tapes are manufactured with fiberglass strands, arranged in a grid or Leno weave pattern. These types of arrangements result in an outer surface, which is not smooth compared to non-mesh-type tapes, which have substantially uniform cross-sections.

The drywall installers who tape the seams, sometimes called “tapers”, frequently have difficulty removing mesh-type drywall tape from a roll. The cut end or edge of the mesh-type drywall tape is difficult to distinguish if the cut end has not been folded back upon itself at the cut end or edge.

While some methods have been proposed to visually detect starting edges for tape materials, these methods are not specific to mesh-type tapes. Rather, these methods seek to detect starting, torn, or cut edges of tape materials having uniform cross-sections and smooth outer surfaces. Although suitable for their intended purpose, these methods are not necessarily applicable to mesh-type drywall tapes.

Given the limitations of the prior art, as well as the considerations noted, there is a clear need for improved mesh-type drywall tapes.

### SUMMARY

A mesh-type drywall tape has a scrim layer with a plurality of lengthwise strands coupled to a plurality of crosswise strands. To form the indexing pattern, the strands are marked with markings. Preferably, the upper surfaces of the strands are so marked.

In one embodiment, the indexing pattern has a v-shape configuration, having diagonal portions that may vary in shape and color. The v-shape pattern repeats itself along the entire length of the tape. In another embodiment, the indexing pattern has a series of substantially parallel markings of different colors along the lengthwise strands that are offset from one another.

The mesh-type drywall tape may further comprise adhesives used to couple or join the strands to one another, and a backing adhesive used to couple or join the tape to drywall surfaces, or other similar surfaces. When produced in a roll-form, the mesh-type drywall tape also may include a cylindrical core upon which the tape is wound.

### BRIEF DESCRIPTION OF THE DRAWINGS

The drawings described herein are for illustrative purposes only and are not intended to limit the scope of the present disclosure. In the drawings:

FIG. 1 is a perspective view of a partially rolled mesh-type drywall tape, showing an indexing pattern;

FIG. 2 is a top view, showing one upper layer of a rolled mesh-type drywall tape;

FIG. 3 is a top plan view of an unrolled section of a mesh-type drywall tape, showing an indexing pattern;

FIG. 4 is a cross-sectional view of the unrolled section of a mesh-type drywall tape shown in FIG. 3 taken along line 4-4; and

FIG. 5 is a top plan view of an unrolled section of a mesh-type drywall tape, showing a second embodiment of an indexing pattern.

### DETAILED DESCRIPTION

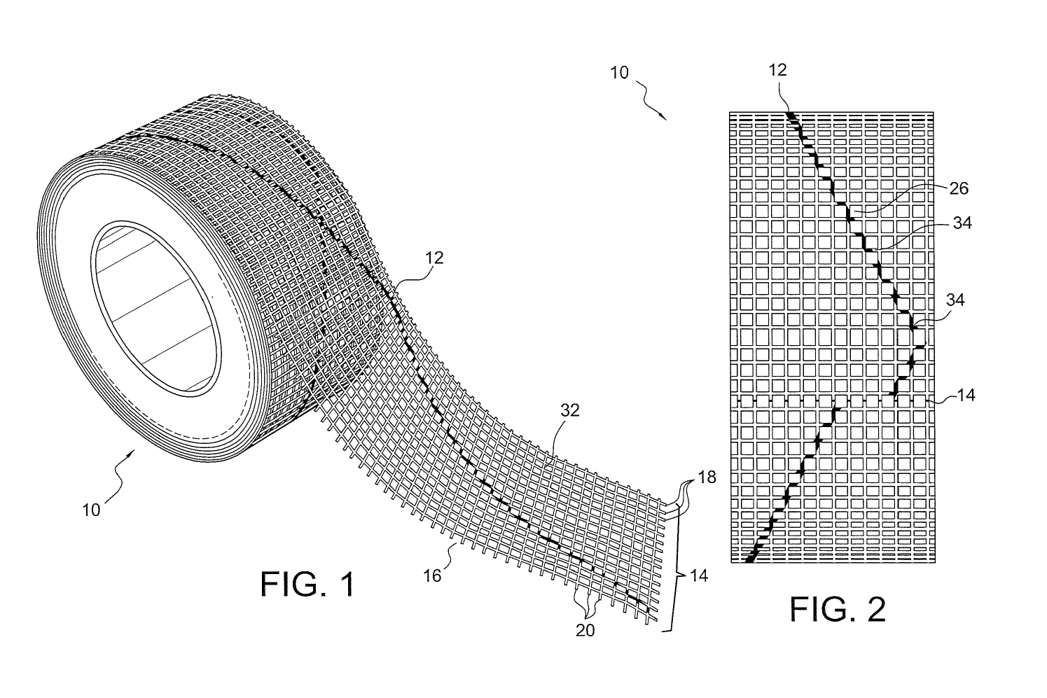

Turning in detail to the drawings, FIGS. 1 and 2 show a mesh-type drywall tape 10 in rolled form, having an indexing pattern 12 used for indicating a tape edge 14. The tape 10 comprises a scrim layer 16 that includes plurality of lengthwise strands 18 and a plurality of crosswise strands 20. Both types of strands 18, 20 comprise one or more strands, fibers or yarns. The strands, fibers or yarns generally are manufactured from fiberglass, or one or more other materials suitable to cover drywall seams. The strands, fibers or yarns also may be prepared with protective elements (not shown), such as coatings, containing one or more antimicrobial additives, antifungal additives, ultraviolet (“uv”) stabilizers and/or elastomeric materials. These protective elements may be used, for example, to protect tapes and also the drywall positioned under the tapes from mold growth.

As used herein, “drywall” refers to panels or sections of building materials, including, but not limited to, gypsum boards, cement boards and wallboards. In typical drywall applications that use mesh-type drywall tapes, sections of drywall are secured against a framework of vertical studs, which are erected as part of a wall, or joists, which are erected as part of a ceiling. After the drywall sections are initially secured, seams remain visible between opposed edges of adjacent drywall sections. Mesh-type drywall tape is installed over such seams, as well as over the screw heads or fasteners joining the drywall sections to the studs or joists. Then, the mesh-type drywall tape is covered with joint compound to cover the seams and create seamless joints.

Mesh-type drywall tapes generally comprise a series of strands that form the mesh. Strands 18, 20 may be formed by coupling together a plurality of yarns or fibers using any known method, such as, but not limited to, twisting. A scrim layer 16 is then formed with multiple strands 18, 20. The scrim layer 16 may be any arrangement suitable for forming mesh-type drywall tapes. In the embodiment shown in FIGS. 1-4, the scrim layer is in a regular square grid type pattern, where crosswise strands 20 are laid on top of the lengthwise strands 18 and coupled or joined to one another, using an adhesive (not shown) on those areas or regions where the strands 18, 20 intersect or contact one another. The scrim layer 16 also may be formed using a weaving pattern, such as the Leno weave pattern, for example.

The mesh-type drywall tape 10 also may include additional backing adhesives 28 (FIG. 4) coupled to the bottom surface 30 of the scrim layer 16. The backing adhesive is used for coupling, joining, or adhering the tape to drywall surfaces.

As shown in the FIGS. 1-4, a portion of the upper surface 32 of the scrim layer includes markings 34 that form the indexing pattern 12. The markings 34 may be applied to the scrim layer 16 before or after adhesives. As used herein, the term “markings” should be construed as any element that may be applied to a scrim layer using any known method(s). For example, a line type marking may be applied to the scrim layer 16, while it is in a flat shape. Alternatively, a marking element may add markings during the rolling of the tape onto a cylindrical core. Suitable marking elements include paints, inks, and stains.

Alternatively, markings 34 include an overlay material that is suitable for attaching or adhering to the scrim layer. The overlay material is any suitable material suitable for use during scrim manufacture. For example, the overlay material may comprise at least one strand or thread of a contrasting color that is attached to or adhered to the scrim layer. In one embodiment, the thread or strand has a contrasting color that is superimposed over the scrim layer. In another embodiment, the markings form an indexing pattern having a series of parallel markings of differing colors along the lengthwise strands, which are offset from one another, as further described below.

The markings may comprise ink, paint, stain, or any other material that changes strand or yarn color, adheres to strands or yarns, or that embeds into strands or yarns. The term “marking” as used herein, is not only surface coatings applied to one or more strands or yarns, but also defined as physical changes to the composition or structure of the strands or yarns. For example, sections of the strands or yarns may be colored throughout the strand or yarn material. The markings also may provide altered areas (not shown) on the strands, such that the tape edge may be detected by feel. For example, inked strands may result in a texturized upper surface. The markings also may modify the textural feel of the strands by etching, for example.

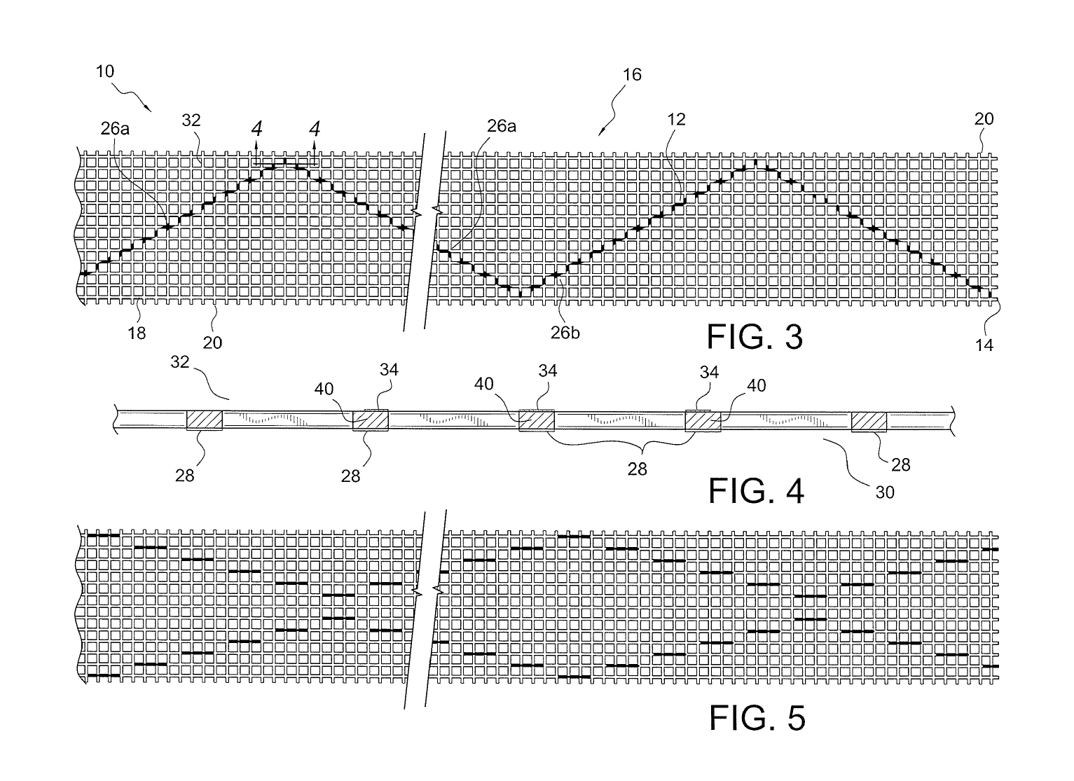

Markings 34 form the indexing pattern 12, as shown particularly in FIGS. 1 to 3. In one embodiment, from a distance, the indexing pattern 12 generally has a v-shaped configuration 36. Each v-shaped configuration 36 includes diagonal portions 26. In a preferred embodiment, the diagonal portions 26 have varying or alternating colors. As one non-limiting example, a first diagonal portion 26a may comprise blue (FIG. 3), while a second diagonal portion 26b may comprise red (FIG. 3). The diagonal portions 26 then repeat in a varying or alternating color pattern of red and blue, along the length of the tape 10.

The indexing pattern 12 is applied to upper surfaces of strands 18, 20 to aid in detection of a tape edge 14. The tape edge 14 may be formed by cutting, tearing, or any other methods that can severe a plurality of strands. As shown in FIG. 2, the tape edge 14 can be seen readily by the discontinuity of the diagonal portions 26 observed at the tape edge 14. In contrast to conventional tape materials, having substantially uniform cross-section, a tape edge, as used herein comprises crosswise strands 20 mesh and/or lengthwise strands 18 having a marking 34. Marked strands 40 provide an indicator for the tape edge 14. Therefore, a user of the tape 10 can determine visually and/or by feel where a tape edge 14 begins.

Often, mesh type drywall tapes are sold in rolled form, as shown in FIG. 1. Typically, to form the rolled tape in this manner, a cylindrical core is used to wind the scrim layer 16, having adhesives.

FIG. 5 shows a second embodiment of a mesh-type drywall tape 50, where a indexing pattern 52 has a series of substantially parallel markings 54 of different colors along a portion of lengthwise strands 56. Marked portions are offset from one another and form a generally v-shaped pattern 52, when viewed from a distance, which repeats along the extended length of the drywall tape. The number of marked portions will depend on the width of the tape and the spacing of the lengthwise strands. Marked portions 58a and 58a′ preferably comprise a first color, while marked portions 58b and 58b′ comprise a second color, 58b and 58c′ comprise a third color, 58d and 58d′ comprise a fourth color, and 58e and 58e′ comprise a fifth color. However, this color pattern is not to be construed as limited, the marked portions may comprise any colorized pattern that aids in indicating a tape edge.

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A mesh-type drywall tape, comprising:
a scrim layer having a plurality of crosswise strands and a plurality of lengthwise strands; and
markings to form an indexing pattern that indicates a tape edge.

2. The mesh-type drywall tape of claim 1, wherein the plurality of crosswise strands comprise fiberglass.

3. The mesh-type drywall tape of claim 1, wherein the plurality of lengthwise strands comprise fiberglass.

4. The mesh-type drywall tape of claim 1, wherein the markings are disposed on a surface of the scrim layer.

5. The mesh-type drywall tape of claim 1, wherein the indexing pattern has a v-shaped configuration.

6. The mesh-type drywall tape of claim 5, wherein the v-shaped configuration comprises a first diagonal portion of a first color and a second diagonal portion of a second color.

7. The mesh-type drywall tape of claim 1, wherein the indexing pattern has a series of colored sections extending in a lengthwise direction of the scrim layer and offset from one another.

8. The mesh-type drywall tape of claim 1, further comprising a backing adhesive.

9. The mesh-type drywall tape of claim 1, further comprising an adhesive that couples the lengthwise strands to the crosswise strands.

10. The mesh-type drywall tape of claim 1, further comprising a cylindrical core coupled to the scrim layer.

11. A method of making a mesh-type drywall tape with a tape edge indicator, comprising:
coupling a plurality of lengthwise extending strands and crosswise extending strands together to form a scrim layer; and
applying an indexing pattern for indicating a tape edge.

12. The method of claim 11, wherein markings are disposed on a surface of the scrim layer as the indexing pattern.

13. The method of claim 11, wherein the indexing pattern has a v-shaped configuration.

14. The method of claim 13, wherein the v-shaped configuration comprises a first diagonal portion of a first color and a second diagonal portion of a second color.

15. The method of claim 11, wherein the indexing pattern has a series of colored sections extending in a lengthwise direction of the scrim layer and offset from one another.

16. The method of claim 11, wherein the indexing pattern is applied to the scrim layer before the scrim layer is rolled or coiled into a roll.

17. The method of claim 11, wherein the indexing pattern is applied to one or more strands before the strands are coupled to form the scrim layer.

18. A mesh-type drywall tape, comprising:
a scrim layer having a plurality of crosswise strands and a plurality of lengthwise strands and markings.
